(19) United States
(12) Patent Application Publication
(10) Pub. No.: US 2025/0322455 A1
(43) Pub. Date: Oct. 16, 2025

(54) SYSTEM AND METHOD FOR AUTOMATED COMMUNITY-BASED CREDIT SCORING

(71) Applicant: Wells Fargo Bank, N.A., San Francisco, CA (US)

(72) Inventors: Ramya Balasubramanian, Secunderabad (IN); Rameshchandra Bhaskar Ketharaju, Hyderabad (IN)

(21) Appl. No.: 18/636,495

(22) Filed: Apr. 16, 2024

(51) Int. Cl. G06Q 40/03; G06Q 50/00

(52) U.S. Cl. CPC G06Q 40/03; G06Q 50/01; G06Q 2220/00

(57) ABSTRACT

Systems and methods are provided, that include collecting, via a data collection system, a social network data from one or more social networks, and receiving a credit voucher from a first entity of the one or more social networks, wherein the credit voucher assigns a credit score to a second entity of the one or more social networks. The systems and methods also include generating a community-based credit score for the second entity of the one or more social networks based on an analysis of the social network data and the credit score, and receiving a request for the community-based credit score sent by a requestor. The systems and methods additionally include providing the community-based credit score to the requestor.

### TECHNICAL FIELD

The present disclosure generally relates to credit scoring, and more specifically to community-based credit scoring.

### BACKGROUND

Certain entities, such as banks, small business owners, suppliers, and the like, participate as entities in one or more networks, such as business networks. For example, small business owners procure financial services from banks, purchase supplies provided by a variety of suppliers, and provide goods and services to the public. Accordingly, the various network entities exchange a variety of goods and services between each other.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. Various ones of the appended drawings merely illustrate example embodiments of the present inventive subject matter and cannot be considered as limiting its scope.

FIG. 1 is a block diagram of a community-assigned credit score ecosystem, according to some examples.

FIG. 2 is a flowchart illustrating a process for automatically generating community-based credit scores 132, according to some examples.

FIG. 3 is a flowchart of a process for creating and participating in a community-assigned credit score ecosystem, according to some examples.

FIG. 4 is a block diagram depicting a machine suitable for executing instructions via one or more processors, according to some examples.

### DETAILED DESCRIPTION

Reference will now be made in detail to specific example embodiments for carrying out the inventive subject matter. Examples of these specific embodiments are illustrated in the accompanying drawings, and specific details are set forth in the following description in order to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

The techniques described herein solve various technical problems such as automating the analysis of large volumes of data, including social network data, to more efficiently derive community-based credit scores via an automated community-based credit evaluation system. The automated community-based credit evaluation system provides for certain outputs, such as credit scores, which can then be used by an institution, such as a bank, to provide for more accurate financial products, such as loans, insurance, closing fees, and so on. The automated community-based credit evaluation system integrates social networking intelligence with banking services to assess and provide financial products to individuals and communities, particularly those who are unbanked or underbanked. In some examples, certain entities, such as banks, have access to information about community members, social influencers, and leaders within social networks, and the existence of communities that are not fully utilizing financial services.

The automated community-based credit evaluation system utilizes knowledge of community dynamics and social networking intelligence. It uses this information to identify key actors within the community, such as leaders and influencers, and assesses the community's financial activities, including those that are unbanked or underbanked. The system can automatically generate credit scores for individuals or groups based on their activities (e.g., farming, gig economy work, sales, bartering, and so on). Accordingly, this includes both monetary and non-monetary transactions, such as bartering, tool lending, and the like. The system evaluates income, including virtual income (e.g., social “currency”) and transactional patterns to assign a credit score. The system allows community members, particularly leaders and influencers, to vouch for other members. This vouching can be binary (e.g., simple recommendation) or carry a range (e.g., a credit score range). The vouching process can lead to temporary credit scores and can be incorporated into smart contracts. The vouching and community-based credit scoring can be encapsulated in smart contracts on a distributed digital ledger, such as an Ethereum blockchain. These contracts can execute automatically or manually, depending on the terms agreed upon by the parties involved.

The system can recommend or guarantee services or financial products based on the community's activities and needs. For example, if a community is known for organizing trips (e.g., community of travel guides), the bank can recommend or guarantee services related to those trips. After a transaction is completed, the system updates the scores of the individuals or groups involved based on the outcome. This could enhance the reputation and creditworthiness of the parties within the community. The system recognizes that individuals may belong to multiple communities and can facilitate transactions or recommendations across these different groups. The bank can underwrite a certain percentage of the risk associated with the guarantees it provides. This underwriting is based on the bank's assessment of the individual or community's assigned credit score, history and transactional influence. The system takes privacy, identity protection, and consent into account when monitoring and utilizing social networking data for financial assessments. In summary, the techniques describe herein bridge a gap between more traditional banking services and community-based services with varying degrees of financial engagement that leverages social networking data and community dynamics to assess creditworthiness, facilitate financial transactions, and expand services while using smart contracts to formalize agreements and guarantees.

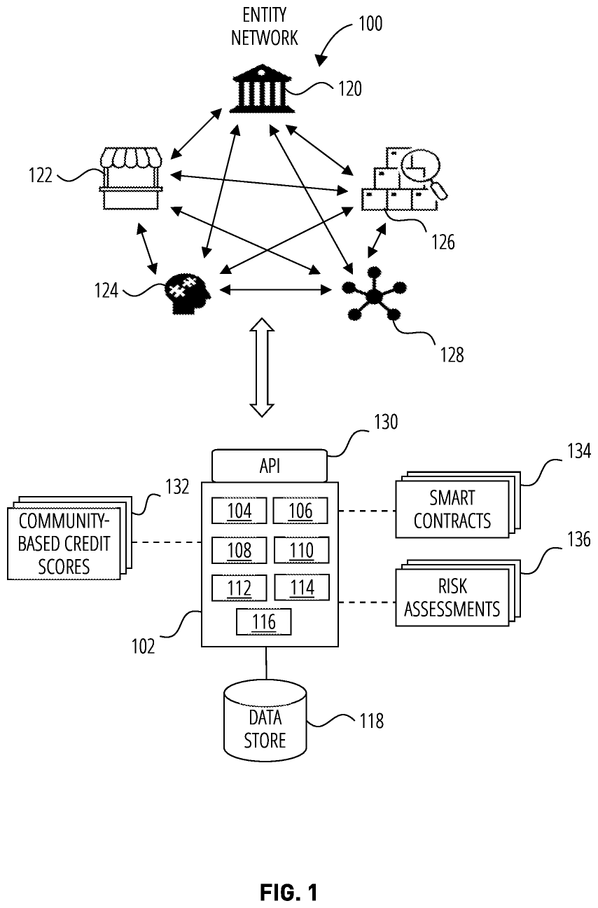

FIG. 1 illustrates an example community-assigned credit score ecosystem 100 and an automated community-based credit evaluation system 102, according to some examples. In the depicted example, the automated community-based credit evaluation system 102 includes a data collection system 104, a non-monetary transaction evaluator 106, a credit scoring system 108, a smart contract system 110, and a risk assessment and underwriting system 112, an authentication system 114, and a user interface (UI) system 116. A data store 118 is also shown, suitable for storing a variety of data. The automated community-based credit evaluation system 102 can be used by various entities 120, 122, 124, 128, 126 to participate as members of the community-assigned credit score ecosystem 100. For example, a financial entity 120 (e.g., retail and commercial bank, investment bank, brokerage firm, mortgage company, and so on) can participate by providing financial products and/or services such as loans, investment products, checking and savings accounts, insurance products, and the like.

Other participant entities include merchant entities 122. The merchant entities 122 sell a variety of goods, including online goods, manage physical store location(s), and so on, and can include a variety of small business. The merchant entities 122 also include entities that produce goods for sale, such as farming entities, restaurants, manufacturing entities (e.g., small manufacturers), and the like. Service provider entities 124 provide a variety of services, such as gig economy services (e.g., drivers, short-term rental providers, long-term rental providers, and the like), consulting services, contractor services, plumbing services, electrician services, software services, legal services, medical and health service providers, and so on. Participant entities can also include suppliers and/or supply chain entities 126, which supply a variety of products including raw materials, manufactured parts, finished goods, and the like. In some cases, an entity of the community-assigned credit score ecosystem 100 can provide merchants goods, but additionally provide services, supplies, or a combination thereof.

Also shown are social networks 128. In some examples, entities in a social network 128 are members of an organized group, such as a farming community, a sales group, a union, a business bureau, and so on. The social network 128 also includes more loosely organized groups of entities, such as friends, influencers, followers, and so on. Entities 120, 122, 124, 126, 128 can interact with the automated community-based credit evaluation system 102, for example, via an application programming interface (API) 130. In certain embodiments, the API 130 is accessed via API keys (e.g., public/private keys) used to provide authentication and security. The API 130 exposes a set of objects (e.g., classes, functions, callable code) to interface with and use the automated community-based credit evaluation system 102, including the data collection system 104, the credit scoring system 108, the smart contract system 110, the risk assessment and underwriting system 112, and the UI system 116. It is to be noted that the automated community-based credit evaluation system 102 and the API 130 can be provided by an entity, such as the financial entity 120, by a third-party (e.g., a party not a member of the community-assigned credit score ecosystem 100 such as a software-as-a-service (SaaS) cloud provider), or a combination thereof.

The data collection system 104 provides for social network data scraping, where data from the social network 128 other social media, and networking platforms, is gathered and collected. In operation, the data collection system 104 provides is programmed to automatically collect data from specified social networks at regular intervals and/or in real-time, and store the collected data in the data store 118. The data collection system 104 identifies and extracts specific types of data, such as posts, comments, likes, shares, group memberships, and/or interaction patterns, for example, which are then provided for use by the credit scoring system 108. The data collected includes transactional data, both monetary and non-monetary. The data collection system 104 additionally builds profiles of users and communities by aggregating data related to their activities, influence, and network dynamics. The data collection system 104 monitors interactions within the community to identify influencers and leaders, followers, friends, and so on. In some examples, the data collection system 104 is customized to search for particular keywords, hashtags, or topics that are indicative of economic activities or community engagement. Further customization is used, for example via custom queries, to adapt to different social networking platforms' APIs and data structures, providing for more flexible and efficient data extraction. The data collection system 104 additionally ensures that data collection practices are in line with certain legal requirements, such as General Data Protection Regulation (GDPR), California Consumer Privacy Act (CCPA), and so on.

The non-monetary transaction evaluator 106 evaluates non-monetary transactions to derive a monetary value. In some examples, queries (e.g., structure query language (SQL) queries, regular expression (regex) queries, wildcard character queries, and so on) are used to identify a good and/or a service involved or being provided via the transaction. For example, a social network post may include “looking to barter a used 2021 Trek e-bike model Y for an electric scooter.” The non-monetary transaction evaluator 106 will then derive a fair market value (FMV) for the bicycle based on queries to certain databases, websites, economic research resources, and the like, such as eBay, BikesForSale.com, and so on. Likewise, a social network post may include “I'm a licensed hairstylist looing to trade haircuts for some plumbing work.” The non-monetary transaction evaluator 106 will then derive the hourly FMV rate for hairstyling and plumbing based on, sites like fash.com, Angie's List, and so on. The derived FMV(s) are then used to assign a non-monetary transaction an actual monetary value.

The credit scoring system 108 processes and interprets certain data stored in the data store 118 (e.g., data collected via the data collection system 104) to generate community-based credit scores 132 that reflects the economic behavior and potential financial reliability of various entities 120, 122, 124, 126, 128. The credit scoring system 108 provides for one or more credit score algorithms that calculates credit scores 132 for each of the entities 120, 122, 124, 126, 128. These algorithms take into account traditional financial data, but additionally use social networking data, transaction history data, community engagement data, and any vouching or guarantees made by other community-assigned credit score ecosystem 100 members. The scoring algorithm can be customized to weight different factors according to their relevance to creditworthiness in specific contexts or communities.

An example credit score algorithm weighs traditional financial data (e.g., payment history, credit utilization factors (e.g., how much available credit is being used), length of credit history factors, types of credit use factors (e.g., credit cards, retail accounts, installment loans, mortgage loans, and so on), new credit factors (e.g., how many new accounts have been opened in a given time period such as a year and how many inquiries are made to a credit report), current debt level factors, financial assets owned factors, income stability factors (e.g., salary consistency, years of employment history), and adds social networking data (e.g., network size and quality factors (e.g., measurements of the number of connections and the creditworthiness of those connections), engagement metrics factors (e.g., analysis, including numbers, of likes, shares, comments, and other interactions that indicate community involvement and influence), and/or sentiment analysis factors (e.g., evaluation of feedback and/or sentiments in posts related to financial matters)).

The example credit score algorithm also adds weighted transaction history data, community engagement data, and/or vouching data. Transaction history data includes monetary transaction factors, such as a review of banking transactions, including frequency and amounts, to gauge financial activity. The transaction history data additionally includes non-monetary transaction factors, such as valuation of bartering and other non-monetary exchanges based on estimated market values via the non-monetary transaction evaluator 106. Community engagement data includes community role factors, such as roles played by members of the community-assigned credit score ecosystem 100, including leader, influencer, friend, active member (e.g., based on count and/or frequency of posts), passive member, and so on, and community support factors, such as number of instances of providing or receiving financial and/or non-financial support, which can indicate trustworthiness and social capital. Vouching or guarantee factors include vouching records that document instances where the individual or community has been vouched for by others, indicating trust, as well as guarantee agreements, which include any guarantees (e.g., contract guarantees) made by or for the individual or community.

In some examples, a credit score algorithm uses an equation such as weight1*factor1*adjustment1+weight1*factor1*adjustment1+ . . . +weightN*factorN*adjustmentN where weightX is a weight (e.g., between 1 to 100) given to a factor (e.g., financial data factors, social network data factors, weighted transaction history factors, community engagement factors, and/or vouching factors), and adjustmentX is an adjustment value that is used to better fit the equation to observed results. The credit scoring system 108 updates the community-based credit scores 132 in real-time or at scheduled intervals, reflecting the most current data available. The credit scoring system 108 generates credit scores 132 for both individuals and groups, recognizing the collective economic activity and influence of communities. The credit scoring system 108 maintains historical data, via the data store 118, to track changes in credit scores over time, thus providing insights into trends and patterns in economic behavior.

The smart contract system 110 facilitates the creation, management, and execution of smart contracts 134. Smart contracts 134 are self-executing contracts with the terms of the agreement directly written into code and executed on a blockchain system. More specifically, the smart contract system 110 is operatively coupled to or included in one or more blockchain platforms to deploy and execute smart contracts 134, providing for enhanced security and immutability. The smart contract system 110 enables users to create smart contracts for various monetary and non-monetary transactions, such as loans, insurance, barter exchanges, borrowing of tools, delivery of products, delivery of services, and so on, using templates or custom parameters. Once a smart contract 134 has been created, the smart contract 134 executes automatically when predefined conditions are met, without the need for intermediaries. The smart contract system 110 additionally provides for a set of pre-defined smart contract templates for common transactions (e.g., buying, bartering, selling), which users can customize as desired. In some examples, the smart contract system 110 provides for smart contract parameter customization, which enables users of the automated community-based credit evaluation system 102 to define specific contract terms and conditions, such as a minimum community-based credit score 132 and/or risk metric included in the risk assessment 136 to automatically execute a smart contract provision, payment schedules to adhere to, delivery schedules, number and/or quality of products/services to be delivered, interest rates, and/or collateral requirements. Accordingly, the smart contract system 110 leverages blockchain technology to enhance trust, reduce costs, and increase efficiency in executing financial and other agreements. The smart contract system's integration with the rest of the automated community-based credit evaluation system 102 enables smart contracts 134 that are informed by more accurate and up-to-date credit scoring and vouching information, providing a more reliable foundation for financial transactions within the community-assigned credit score ecosystem 100.

The risk assessment and underwriting system 112 evaluates the potential risks associated with extending credit or other financial services based on the credit scores 132, social networking data, transaction history, community engagement, and vouching or guarantees. This system helps to determine the terms of credit or services offered and aids in ensuring that the level of risk taken on by the lender or service provider is within acceptable limits and outputs risk assessments 136. For example, the risk assessment and underwriting system 112 assesses the likelihood of default or other adverse events based on certain data points and a set of underwriting criteria. The data points include an entity's community-based credit score 132, factors used to create the credit score 132, economic trends, and/or industry-specific risk factors (e.g., weather and climate risks in agriculture, risks due to changes in consumer preference in the retail industry, fuel price risks, and so on). The underwriting criteria includes a set of rules for approving, denying, and/or or modifying the terms of financial services based on risk levels. The underwriting criteria further includes rules to comply with internal policies, external regulations, and laws.

In some examples, the risk assessment and underwriting system 112 uses statistical models and/or machine learning algorithms to predict risk based on historical data and trends. For example, logistic regression is used to predict the probability of a binary outcome, such as loan default (yes/no) based on applying maximum-likelihood estimation (MLE) to data such as the entity's community-based credit score 132, factors used to create the credit score 132, the economic trends, and/or the industry-specific risk factors. Linear regression is used to predict future risk for an entity based on historical data sets of the entity's community-based credit score 132, factors used to create the credit scores 132, the economic trends, and/or the industry-specific risk factors. Gradient Boosting Machine (GBM) models are used to build an additive risk model in a forward stage-wise fashion, allowing for the optimization of arbitrary differentiable loss functions. Predictor variables use for the GBM model (e.g., risk model) include entity's community-based credit score 132, factors used to create the credit score 132, the economic trends, and/or the industry-specific risk factors. Likewise, Support Vector Machine (SVM) models classify data (e.g., entity's community-based credit score 132, factors used to create the credit score 132, the economic trends, and/or the industry-specific risk factors) by finding the best hyperplane that separates all data points of one class from those of the other class, and are then applied for risk prediction. Neural Network models are also used that model more complex relationships between inputs and outputs or patterns in data (e.g., entity's community-based credit score 132, factors used to create the credit score 132, the economic trends, and/or the industry-specific risk factors) through a system of interconnected layers of nodes.

Bayesian models are also used, that apply Bayes' theorem to update the probability for a hypothesis as more evidence or information becomes available. For example, as historical values for the entity's community-based credit score 132, factors used to create the credit score 132, the economic trends, and/or the industry-specific risk factors become available, the Bayesian models update probabilities, for example, of an entity missing payment(s), defaulting on a loan, and so on. Data mining techniques, such as clustering, are also used. Clustering groups a set of objects in such a way that objects in the same group are more similar to each other than to those in other groups. Accordingly, entities deemed members of a group likely to default or members of group that is not likely to default can be identified.

The risk assessments 136 include reports that include a risk metric (e.g., between 1 to 100) that corresponds to a risk of default, a risk of non-payment, a risk of fraud, risk of bankruptcy, and so on, for a given entity 120, 122, 124, 126, 128. The risk assessments 136 also includes details on how the risk metric(s) were calculated, such as model type (e.g., type of statistical model, type of neural network model, and so on), risk factors used (e.g., credit scores used (including community-based credit scores 132), factors used to create the credit score 132, the economic trends, and/or the industry-specific risk factors), suggested terms and conditions for any financial product to be offered (e.g., loan, credit card, line of credit), such as interest rates, repayment schedules, and collateral requirements. The risk assessments 136 also include strategies to mitigate identified risks, such as requiring a co-signer or additional collateral.

The authentication system 114 authenticates users of the automated community-based credit evaluation system 102, for example, via multi-factor authentication. A user of the automated community-based credit evaluation system 102 enters a user/password combination, and the authentication system 114 will verify the combination and transmit a code to the user to further authenticate a login into the automated community-based credit evaluation system 102. Communications of the automated community-based credit evaluation system 102 are encrypted, for example using Transport Layer Security (TLS), to prevent eavesdropping and man-in-the-middle attacks. The authentication system 114 also provides for password policies suitable for using complex passwords and regular changes to reduce the risk of compromise.

The UI system 116 provides for a graphical user interface that includes windows, icons, menus, buttons, and all the other elements that are manipulated by the user with a pointing device like a mouse or touchpad. Command-Line Interfaces (CLIs) are also provided via the UI system 116. The CLIs allow users to interact with the automated community-based credit evaluation system 102 by typing commands into a terminal or command prompt. The UI system 116 also provides for touch interfaces designed for touch screens. These touch interfaces allow users to interact with the automated community-based credit evaluation system 102 through touch gestures such as tapping, swiping, and pinching. Voice User Interfaces (VUIs) are also included in the UI system 116. The VUIs enable interaction with the automated community-based credit evaluation system 102 through voice or speech commands.

The data store 118 is a database, such as a relational database, an object-oriented database, a cloud-based database, and the like, that is operatively coupled to the automated community-based credit evaluation system 102. The data store 118 stores information such as the risk assessments 136, the smart contracts 134, the community-based credit scores 132, social media information, mentoring information, and so on. In some examples, the data store 118 is encrypted and the data anonymized to increase security of the automated community-based credit evaluation system 102.

In operations, the community-based credit scores 132, the smart contracts 134, and/or the risk assessments 136, are used by the entities 120, 122, 124, 126, 128 to enhance their decision-making processes and to provide certain offerings. For example, the offerings include financial products (e.g., loans, lines of credit, credit cards), transaction and payment services (e.g., wire transfers, mobile payment services, point-of-sale services, and so on), investment products (e.g., stock and bonds, cryptocurrencies), and so on, which can be automatically provided based on the community-based credit scores 132, the smart contracts 134, and/or the risk assessments 136. Indeed, even without a traditional financial history (e.g., credit history, banking history), an entity 120, 122, 124, 126, 128 can now financially participate in a variety of transactions based on the community-based credit scores 132, the smart contracts 134, and/or the risk assessments 136.

Some non-limiting examples of use of the community-based credit evaluation system 102 include:

Housing and Real Estate—Rental Screening: Property management companies and landlords use community-based credit scores 132 and/or risk assessments 136 to evaluate potential tenants, especially those with limited credit history. Smart contracts 134 execute leasing agreements and renewals automatically based on the community-based credit scores 132 and/or risk assessments 136, including automatic lease payments. Cooperative Housing: Housing cooperatives use the community-based credit scores 132 to assess the reliability and community involvement of potential members.

Peer-to-Peer Services—Gig Economy Platforms: Gig economy platforms would use community-based credit scores 132 and risk assessments 136 to assess the reliability of users who wish to rent out their homes, cars, or other assets. Smart contracts 134 are then used to provide for payment amounts, including scheduled payments, based on the community-based credit scores 132 and/or the risk assessments 136. Peer-to-Peer Lending: Platforms facilitating loans between individuals could use the community-based credit scores 132 and/or the risk assessments 136 to gauge the creditworthiness of borrowers and set interest rates.

Retail and E-Commerce—Payment Plans: Retailers offering financing options for big-ticket items use the community-based credit scores 132 and/or risk assessments 136 to determine eligibility and terms for payment plans. The smart contracts 134 then automatically execute the payment plans. Insurance—Premium Calculation: Insurance companies could consider community-based credit scores 132 and/or risk assessments 136 when calculating premiums for policies, assuming a correlation between community standing and risk behavior. Payments are then collected via smart contracts 134. Peer-to-Peer Insurance: Community-based credit scores 132 and/or risk assessments 136 facilitate the growth of peer-to-peer insurance models, where individuals pool resources and share risks.

Utilities and Telecommunications—Service Deposits: Utility companies could use community-based credit scores 132 and/or risk assessments 136 to determine whether a deposit is required for new service installations. Contract Terms: Telecommunication firms might offer more favorable contract terms via smart contracts 134 based on higher community-based credit scores 132 and less risky risk assessments 136. Online Marketplaces—Trustworthiness Indicators: Online marketplaces could display their community-based credit scores 132 as a trustworthiness indicator for buyers and sellers, similar to a rating or review system. Collaborative Projects—Project Funding: Crowdfunding platforms could use community-based credit scores 132 to highlight projects initiated by individuals with strong community support and engagement.

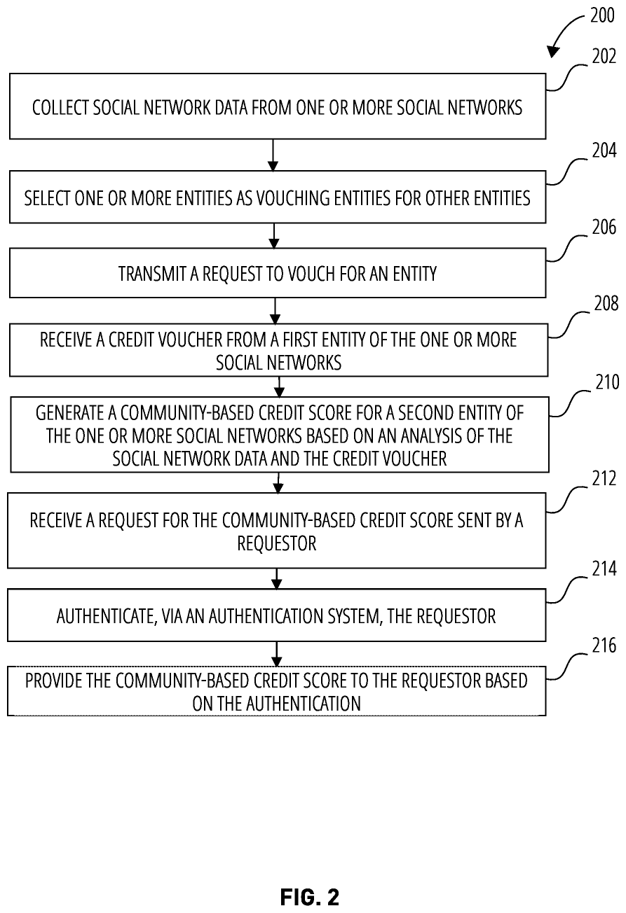

FIG. 2 is a flowchart of an embodiment of process 200 for automatically generating community-based credit scores 132, according to some examples. In the depicted example, the process 200 provides, at block 202, for the collection of social network data. In one example, the process 200 uses the data collection system 104 to collect data from specified social networks (e.g., social network 128) at regular intervals and/or in real-time, and to store the collected data in the data store 118. The data collection at block 202 identifies and extracts specific types of data, such as posts, comments, likes, shares, group memberships, and/or interaction patterns. Indeed, the data collected includes transactional data, both monetary and non-monetary. Interaction patterns include a barter transaction, a loan request, a loan provisioning, a loan payment (monetary payment and/or non-monetary payment), a borrowing of a tool, a request for a product, a delivery of the product, a review of the product, a request for a service, a delivery of the service, and/or a review of the service. Relevant data, including interaction patterns, are identified via queries (e.g., SQL queries, regex queries, wildcard character queries, and so on) on the social network data collected.

The process 200, at block 204, selects one or more entities 120, 122, 124, 126, 128, referred to as vouching entities, which will vouch for or attest for other entities 120, 122, 124, 126, 128, referred to as vouchee entities. More specifically, the vouching entities will assign a credit score to attest for the reliability and credit-worthiness of vouchee entities. In the depicted example, the process 200 selects one or more key actors in the social network 128 as the vouching entities. Key actors include community leaders, social influencers, elders or respected individuals, and the like. In some examples, a follower count, an engagement rate, a posting rate (e.g., frequency of postings), and/or a comment rate (e.g., frequency of responding to postings) is used to identify key actors. The engagement rate is calculated by taking the total engagement (sum of likes, comments, shares, etc.) a post receives and dividing it by the total number of followers (or reach/impressions) the account has, then multiplying by 100 to get a percentage. A high follower count, engagement rate, posting rate, and/or comment rate can be indicative of key actors in a social network.

The process 200, at block 206, then transmits a request to the selected vouching entities (e.g., key actors), the request asking the selected vouching entities to vouch for a particular entity 120, 122, 124, 126, 128. The request includes authentication information that verifies that the request is being sent by the automated community-based credit evaluation system 102, such as using a security certificate, a private/public exchange of keys, security tokens, and so on. At block 208, the process 200 then receives a credit voucher from the vouching entity that assigns a credit score to one or more of the entities 120, 122, 124, 126, 128. That is, one or more of the vouching entities 120, 122, 124, 126, 128 responds to the request from block 204 by vouching or attesting for, another one or more of the vouchee entities 120, 122, 124, 126, 128 via a credit score. In some examples, the credit score is in the same range as a Fair Isaac Corporation (FICO) credit score, such as between 300 and 850. In other examples, the credit score uses another ranges, such as between 1 and 100, 1 and 10, and the like.

The process 200 then generates, at block 210, the community-based credit score 132. In one example, the community-based credit scores 132 is a combination of the credit score provided by one or more vouching entities and a credit score automatically derived via analysis of one or more social networks via the credit scoring system 108. As mentioned earlier, the credit scoring system 108 applies, in one example, a credit score algorithm that weighs traditional financial data (e.g., payment history, credit utilization factors (e.g., how much available credit is being used), length of credit history factors, types of credit use factors (e.g., credit cards, retail accounts, installment loans, mortgage loans, and so on), new credit factors (e.g., how many new accounts have been opened in a given time period such as a year and how many inquiries are made to a credit report), current debt level factors, financial assets owned factors, income stability factors (e.g., salary consistency, years of employment history), and adds social networking data (e.g., network size and quality factors (e.g., measurements of the number of connections and the creditworthiness of those connections), engagement metrics factors (e.g., analysis, including numbers, of likes, shares, comments, and other interactions that indicate community involvement and influence), and/or sentiment analysis factors (e.g., evaluation of feedback and/or sentiments in posts related to financial matters)).

The example credit score algorithm also adds weighted transaction history data, community engagement data, and/or vouching data. Transaction history data includes monetary transaction factors, such as a review of banking transactions, including frequency and amounts, to gauge financial activity. The transaction history data additionally includes non-monetary transaction factors, such as valuation of bartering and other non-monetary exchanges based on estimated fair market values via the non-monetary transaction evaluator 106. Community engagement data includes community role factors, such as roles played by members of the community-assigned credit score ecosystem 100, including leader, influencer, friend, active member (e.g., based on count and/or frequency of posts), passive member, and so on, and community support factors, such as number of instances of providing or receiving financial and/or non-financial support, which can indicate trustworthiness and social capital. Vouching or guarantee factors include the credit scores provided by one or more vouching entities.

In one example, a credit score algorithm uses an equation such as weight1*factor1*adjustment1+weight1*factor1*adjustment1+ . . . +weightN*factorN*adjustmentN where weightX is a weight (e.g., between 1 to 100) given to a factor (e.g., financial data factors, social network data factors, weighted transaction history factors, community engagement factors, and/or vouching factors), and adjustmentX is an adjustment value that is used to better fit the equation to observed results. In this example, the one or more vouched credit scores are incorporated by adding them as another set of factors. Accordingly, the full equation becomes weight1*factor1*adjustment1+ . . . +weightN*factorN*adjustmentN+Vweight1*Vfactor1*Vadjustment1+ . . . +VweightN*VCreditScoreN*VadjustmentN where VweightX is a weight assigned to a vouched credit score X, and VadjustmentX is an adjustment value for the vouched credit score X. In some examples, the VweightX is assigned based on the community-based credit score 132 of the vouching entity. The VadjustmentX is increased to give the vouching credit scores higher importance, and decreased to lower the vouching credit scores importance.

The process 200, at block 212, receives a request, such as a credit verification request, for one or more of the community-based credit scores 132. For example, a requestor entity 120, 122, 124, 126, 128 sends the request, via the API 130, to the automated community-based credit evaluation system 102, requesting the community-based credit score 132 of a requestee entity 120, 122, 124, 126, 128. The process 200, at block 214, then authenticates, via the authentication system 114, the incoming request for the community-based credit scores 132. The authentication includes verifying that the requestor entity is allowed to receive the one or more community-based credit scores 132 of requestee entities. That is, in some examples, the credit verification request results in a second transmission to the requestee entities 120, 122, 124, 126, 128 requesting permission to forward their respective community-based credit scores 132 to the requestor entity. Once the requestee entities have approved the request, the process 200 then provides, at block 216, the community-based credit scores 132 and/or risk assessments 136 to the requesting entities.

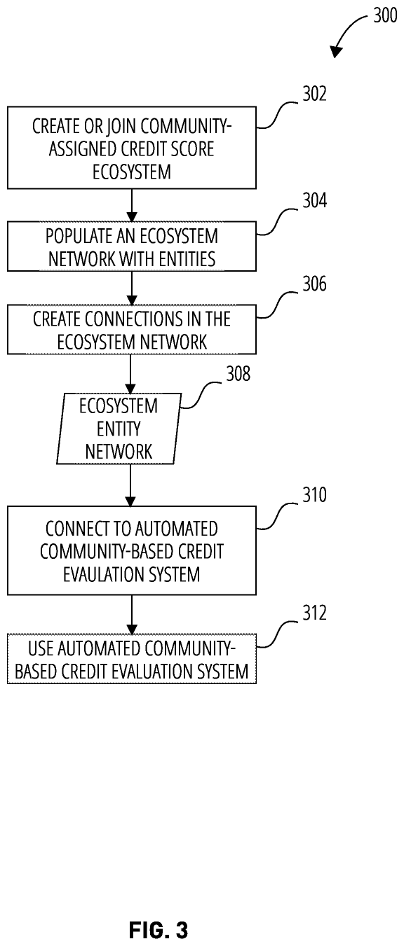

FIG. 3 is a flowchart of a process 300 for creating and participating in a community-assigned credit score ecosystem 100, according to some examples. In the depicted example, the process 300 enables a user, at block 302, to create or to join a community-assigned credit score ecosystem 100. The user can be an entity 120, 122, 124, 126, 128 authenticated via the authentication system 114 to create and/or to join a community-assigned credit score ecosystems 100. For example, the user can log into a website or a mobile “app” and use the automated community-based credit evaluation system 102 to enter the name of a new community-assigned credit score ecosystem 100 or to search for an existing community-assigned credit score ecosystem 100.

The process 300, at block 304, populates an entity network of the community-assigned credit score ecosystem 100 with one or more entities. For example, in addition to the “creator” entity that created the community-assigned credit score ecosystem 100, user members of the creator entity (e.g., members of a social network 128, employees of a financial entity 120, and so on) can then add other entities by selecting, for example, from a list of entities in a drop-down list of the website or mobile app, one or more entities to add. The entities selected will then automatically receive notifications (e.g., via email) to confirm that they would like to join then community-assigned credit score ecosystem 100.

The process 300 then, at block 306, creates connections (e.g., graph edges) in the ecosystem network entity (e.g., ecosystem entity network 308) that are used to connect two or more entities together. For example, a visual graph showing all nodes and any current edges between nodes can be presented, were each node is an entity of the ecosystem entity network 308 and each edge is a relationship between two entities. The user can then create a new edge between to nodes (e.g., entities) to define a new relationship. The two entities will then receive a notification to accept the new relationship (e.g., vendor relationship, supplier relationship, and so on). Various virtual groups, such as farming groups, gig economy groups, marketplaces, virtual supply chains, and so on, can thus be created. For example, a linking several supplier entities 126 via edges creates virtual relationships where a first supplier sends goods to a second supplier which then processes the goods and sends them to a third supplier, and so on, using barter and/or monetary transactions. Likewise, linking several merchant entities 122 and/or service provider entities 124 creates a virtual marketplace, where the various merchant entities 122 can sell a variety of goods and/or services.

The process 300 then connects, at block 310, one or more users to the automated community-based credit evaluation system 102. For example, the authentication system 114 is used to enter a login/password combination and multifactor authentication to provide access to the automated community-based credit evaluation system 102. The process 300 then uses, at block 312, the automated community-based credit evaluation system 102 to provide community-based credit scores 132, risk assessments 136, and/or smart contracts 134.

As mentioned earlier, members entities 120, 122, 124, 126, 128 provide various products and services. For example, the financial entity 120 receives a request from another entity 120, 122, 124, 126, 128 to provide financial products and/or financial services. The financial entity 120 then will use the automated community-based credit evaluation system 102 to generate the community-based credit scores 132 for the requesting entity 120, 122, 124, 126, 128, and/or a risk assessment 136. In one example, a simple comparison of the community-based credit scores 132 and/or risk metric included in the risk assessment 136 against a minimum credit score and/or risk value can then be used to automatically deliver the requested products. Indeed, even an unbanked entity can now be processed via the community-based credit scores 132 and/or risk assessments 136. In some examples, delivery includes using a smart contract 134 to automatically fund a loan amount, for example. Accordingly, the techniques described herein provide for enhanced flexibility and a collaborative approach to deriving and using credit scores.

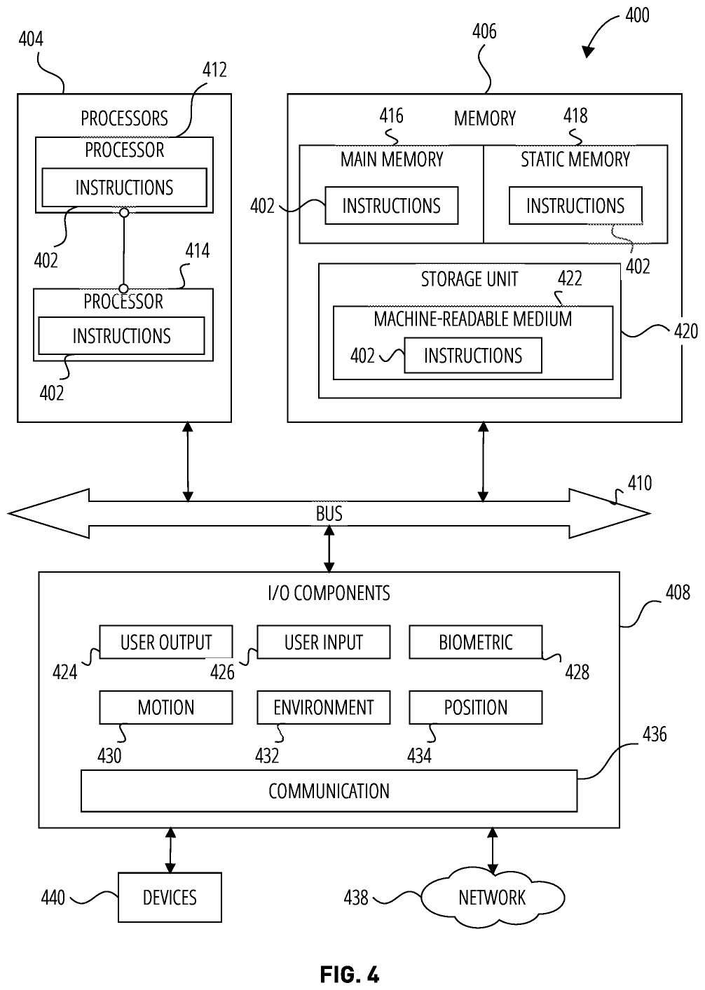

FIG. 4 is a diagrammatic representation of a machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the processes or methods described herein, such as the processes 200 and 300. The instructions 402 transform the general, non-programmed machine 400 into a particular machine 400, e.g., the automated community-based credit evaluation system 102, programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 416, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 434 include location sensor components (e.g., a global positioning system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 1200 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a universal serial bus (USB) port), internet-of-things (IoT) devices, and the like.

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

The techniques described herein provide for the automatic derivation and use of community-based credit scores.

What is claimed is:

1. A method, comprising:
collecting, via a data collection system, social network data from one or more social networks;
receiving a credit voucher from a first entity of the one or more social networks, wherein the credit voucher assigns a credit score to a second entity of the one or more social networks;
generating a community-based credit score for the second entity of the one or more social networks based on an analysis of the social network data and the credit score;
receiving a request for the community-based credit score sent by a requestor; and
providing the community-based credit score to the requestor.

2. The method of claim 1, wherein receiving the credit voucher from the first entity comprises:
analyzing the social network data to identify a key actor within a community of the social networks, wherein the community includes the second entity;
sending a credit vouching request to the key actor to assign the credit score to the second entity; and
receiving from the key actor the credit voucher based on the credit vouching request, wherein the first entity comprises the key actor.

3. The method of claim 2, wherein analyzing the social network data to identify the key actor comprises identifying the key actor based on a follower count, an engagement rate, a posting rate, a comment rate, or a combination thereof.

4. The method of claim 1, wherein generating the community-based credit score for the second entity based on the analysis of the social network comprises:
generating a social network credit score based on the analysis of the social network; and
combining, via a weighing equation, the social network credit score with the credit score to derive a combined weighted credit score, wherein the community-based credit score comprises the combined weighted credit score.

5. The method of claim 4, wherein generating the social network credit score based on the analysis of the social network comprises analyzing a monetary transaction and a non-monetary transaction to determine the social network credit score.

6. The method of claim 5, wherein analyzing the monetary and a non-monetary transaction to determine the social network credit score comprises analyzing the non-monetary transaction to derive a monetary value and combining the monetary value with the monetary transaction to determine the social network credit score.

7. The method of claim 6, wherein analyzing the non-monetary transaction to derive a monetary value comprises:
identifying a good, a service, or a combination thereof, being provided via the non-monetary transaction;
determining a fair market value (FMV) for the good, the service, or the combination thereof; and
assigning the FMV as the monetary value.

8. The method of claim 5, wherein the non-monetary transaction comprises a barter transaction, a tool-lending transaction, a time banking transaction, a service transaction, or a combination thereof.

9. The method of claim 1, wherein the social network data includes at least one of a social network post, a social network comment, a social network like, a share, a group membership in the one or more social networks, or an interaction pattern between entities of the one or more social networks.

10. The method of claim 9, wherein the interaction pattern comprises a barter transaction, a loan request, a loan provisioning, a loan payment (monetary payment and/or non-monetary payment), a borrowing of a tool, a request for a product, a delivery of the product, a review of the product, a request for a service, a delivery of the service, a review of the service, or a combination thereof.

11. The method of claim 1, further comprising encapsulating the community-based credit score in a smart contract and entering the smart contract in a distributed digital ledger.

12. The method of claim 11, wherein the smart contract is configured to automatically execute a smart contract provision based on the community-based credit score having at least a minimum score.

13. The method of claim 1, further comprising:
receiving a request to provide a financial product, a financial service, or a combination thereof, to the second entity;
deriving a risk assessment for providing the financial product, the financial service, or the combination thereof, to the second entity based on the community-based credit score; and
delivering the financial product, the financial service, or the combination thereof; when a risk metric included in the risk assessment is higher than a minimum risk value.

14. The method of claim 13, wherein deriving the risk assessment comprises:
applying the community-based credit score as input into a risk assessment model; and
executing the risk assessment model to derive the risk assessment metric, wherein the risk assessment model comprises at least one of a logistic regression model, a linear regression model, a Gradient Boosting Machine (GBM) model, a Support Vector Machine (SVM) model, or Neural Networks model.

15. The method of claim 1, wherein the second entity comprises an unbanked entity of the one or more social networks that does not have a bank account.

16. The method of claim 1, wherein the second entity comprises a member of the one or more social networks that does not have a credit history.

17. A system comprising:
one or more hardware processors; and
at least one memory storing instructions that cause the one or more hardware processors to perform operations comprising:
collecting, via a data collection system, a social network data from one or more social networks;
receiving a credit voucher from a first entity of the one or more social networks, wherein the credit voucher assigns a credit score to a second entity of the one or more social networks;
generating a community-based credit score for the second entity of the one or more social networks based on an analysis of the social network data and the credit score;
receiving a request for the community-based credit score sent by a requestor; and
providing the community-based credit score to the requestor.

18. The system of claim 17, wherein receiving the credit voucher from the first entity comprises:
analyzing the social network data to identify a key actor within a community of the social networks, wherein the community includes the second entity;
sending a credit vouching request to the key actor to assign the credit score to the second entity; and
receiving from the key actor the credit voucher based on the credit vouching request, wherein the first entity comprises the key actor.

19. A machine-readable medium storing instructions that, when executed by a computer system, cause the computer system to perform operations comprising:
collecting, via a data collection system, a social network data from one or more social networks;
receiving a credit voucher from a first entity of the one or more social networks, wherein the credit voucher assigns a credit score to a second entity of the one or more social networks;
generating a community-based credit score for the second entity of the one or more social networks based on an analysis of the social network data and the credit score;
receiving a request for the community-based credit score sent by a requestor; and
providing the community-based credit score to the requestor.

20. The machine-readable medium storing instructions of claim 19, wherein receiving the credit voucher from the first entity comprises:
analyzing the social network data to identify a key actor within a community of the social networks, wherein the community includes the second entity;
sending a credit vouching request to the key actor to assign the credit score to the second entity; and
receiving from the key actor the credit voucher based on the credit vouching request, wherein the first entity comprises the key actor.
